(19) United States
(12) Patent Application Publication
(10) Pub. No.: US 2025/0323893 A1
(43) Pub. Date: Oct. 16, 2025

(54) MULTI-CLUSTER ACCESS METHOD AND SYSTEM

(71) Applicant: JINGDONG TECHNOLOGY INFORMATION TECHNOLOGY CO., LTD., Beijing (CN)

(72) Inventor: Honglin LI, Beijing (CN)

(21) Appl. No.: 18/865,271

(22) PCT Filed: Feb. 1, 2023
(86) PCT No.: PCT/CN2023/074093

§ 371 Date: Nov. 12, 2024

(30) Foreign Application Priority Data
Jul. 19, 2022 (CN) 202210847314.X

(51) Int. Cl. H04L 61/5007; H04L 12/46; H04L 67/104

(52) U.S. Cl. CPC H04L 61/5007; H04L 12/4641; H04L 67/1044

(57) ABSTRACT

Provided are a multi-cluster access method and system. The method includes synchronizing resources between a primary cluster and sub-clusters; sending relevant information of synchronized resources to a data plane; receiving a plurality of virtual IP addresses feedback from the data plane; and configuring each resource with a virtual IP address corresponding to a cluster access request.

### CROSS-REFERENCE TO RELATED APPLICATIONS

The present disclosure is based on and claims priority of CN patent application Ser. No. 202210847314.X, filed on Jul. 19, 2022, the disclosure of which is hereby incorporated into this disclosure by reference in its entirety.

### TECHNICAL FIELD

This disclosure relates to the field of computer technology, particularly to a multi-cluster access method and system.

### BACKGROUND

Ingress provides a set of routing rules for requests entering a cluster. As a cluster gateway solution for k8s (Kubernetes), Ingress enables calls between services in a cluster, but it cannot provide multi-cluster access.

### SUMMARY

According to an aspect of the present disclosure, there is provided a multi-cluster access method, comprising: synchronizing resources between a primary cluster and sub-clusters; sending relevant information of synchronized resources to a data plane; receiving a plurality of virtual IP addresses feedback from the data plane; and configuring each resource with a virtual IP address corresponding to a cluster access request.

In some embodiments, the resource synchronization comprises: interacting, by a cluster manager in the primary cluster, with a cluster manager in each sub-cluster, obtaining the resource of each pod in each sub-cluster, and synchronizing the resource of each pod in the primary cluster to each sub-cluster.

In some embodiments, the resource synchronization further comprises: storing the resource of each pod in a database, and storing snapshot information corresponding to the resource of each pod in a Custom Resource Definition (CRD) file.

In some embodiments, configuring the virtual IP address comprises: binding the snapshot information corresponding to the resource of each pod to a virtual IP address.

In some embodiments, one or more of querying, creating, updating, and deleting operations are performed on the CRD file based on user instructions.

In some embodiments, binding the virtual IP address of each pod to a corresponding domain name.

In some embodiments, sending load balancing rules to the data plane, wherein the virtual IP addresses are generated based on the load balancing rules and relevant information of resources.

In some embodiments, obtaining the resource of each pod in each sub-cluster comprises: obtaining a kubeconfig file of each sub-cluster in a configmap manner, wherein clusterinfo crd in the kubeconfig file is configured to store configuration information of the corresponding cluster.

According to an aspect of the present disclosure, there is provided a multi-cluster access system, comprising: a cluster manager configured to synchronize resources between a primary cluster and sub-clusters; and a load balancer controller configured to send relevant information of synchronized resources to a data plane, receive a plurality of virtual IP addresses feedback from the data plane, and configure each resource with a virtual IP address corresponding to a cluster access request.

In some embodiments, the cluster manager is configured to interact with a cluster managers in each sub-cluster, obtain the resource of each pod in each sub-cluster, and synchronize the resource of each pod in the primary cluster to each sub-cluster.

In some embodiments, a Custom Resource Definition (CRD) file configured to store snapshot information corresponding to the resource of each pod.

In some embodiments, the load balancer controller is configured to bind the snapshot information of the resource of each pod to a virtual IP address.

In some embodiments, one or more of querying, creating, updating, and deleting operations are performed on the CRD file based on user instructions.

In some embodiments, a global domain name system configured to bind the virtual IP address of each pod to a corresponding domain name.

In some embodiments, the load balancer controller is further configured to send load balancing rules to the data plane, wherein the virtual IP addresses are generated based on the load balancing rules and relevant information of resources.

In some embodiments, the cluster manager is configured to obtain a kubeconfig file of each sub-cluster in a configmap manner, wherein clusterinfo crd in the kubeconfig file is configured to store configuration information of the corresponding cluster.

According to an aspect of the present disclosure, there is provided a multi-cluster access system, comprising: a memory; and a processor coupled to the memory, the processor configured to perform the multi-cluster access method described above based on instructions stored in the memory.

According to a still another aspect of the present disclosure, there is also provided a non-transitory computer readable storage medium having stored thereon computer program instructions that, when executed by a processor, implement the multi-cluster access method described above.

According to another aspect of the present disclosure, there is further provided a computer program, comprising: instructions that, when executed by a processor, cause the processor to execute the multi-cluster access method described above.

Other features and advantages of the present invention will become apparent from the following detailed description of exemplary embodiments of the present disclosure with reference to the accompanying drawings.

### BRIEF DESCRIPTION OF THE DRAWINGS

The accompanying drawings, which are incorporated in and constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 is a flowchart of a multi-cluster access method according to some embodiments of the present disclosure;

FIG. 2 is a flowchart of a multi-cluster access method according to other embodiments of the present disclosure;

FIG. 3 is a structure diagram of a multi-cluster access system according to some embodiments of the present disclosure;

FIG. 4 is a structure diagram of a multi-cluster access system according to other embodiments of the present disclosure;

FIG. 5 is a structure diagram of a multi-cluster access system according to still other embodiments of the present disclosure; and

FIG. 6 is a structure diagram of a multi-cluster access system according to further embodiments of the present disclosure.

### DETAILED DESCRIPTION

Various exemplary embodiments of the present disclosure will now be described in detail with reference to the accompanying drawings. Notice that, unless otherwise specified, the relative arrangement, numerical expressions and values of the components and steps set forth in these examples do not limit the scope of the invention.

At the same time, it should be understood that, for ease of description, the dimensions of the various parts shown in the drawings are not drawn to actual proportions.

The following description of at least one exemplary embodiment is in fact merely illustrative and is in no way intended as a limitation to the invention, its application or use.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an item is defined in a drawing, there is no need for further discussion in the accompanying drawings.

For a clear understanding of the object of the present disclosure, its technical solution and advantages, the present disclosure will be further described in detail below in conjunction with the accompanying drawings and embodiments.

It should be noted that the collection, use, storage, sharing, and transfer of user personal information involved in the technical solution of this disclosure comply with relevant laws and regulations, and require notification to users and obtaining their consent or authorization. Where applicable, User Personal Information will be subject to de-identification, anonymization and/or encryption processes.

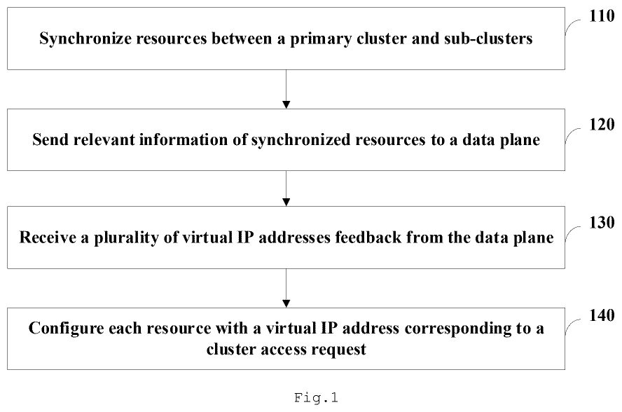

FIG. 1 is a flowchart of a multi-cluster access method according to some embodiments of the present disclosure, which is performed by the control plane.

In step 110, a primary cluster synchronizes resources with sub-clusters.

In some embodiments, a cluster manager in the primary cluster can be used to achieve resource synchronization between the primary cluster and the sub-clusters, and the primary cluster is able to obtain resource information of each pod in each sub-cluster.

In some embodiments, the resource of each pod is stored in a database, and snapshot information corresponding to the resource of each pod is stored in a Custom Resource Definition (CRD) file.

in step 120, relevant information of the synchronized resources is sent to a data plane.

In some embodiments, a load balancer controller monitors the snapshot information of each pod in the CRD file and synchronizes the snapshot information of the pod to the data plane.

In some embodiments, the load balancer controller synchronizes load balancing rule information stored in the CRD file to the data plane.

In step 130, a plurality of virtual IP addresses feedback from the data plane are received.

In some embodiments, the data plane generates the plurality of virtual IP addresses based on load balancing rules and the snapshot information of each pod, and sends the virtual IP addresses to the load balancer controller.

In step 140, each resource is configured with a virtual IP address corresponding to a cluster access request.

In some embodiments, after a user sends an access request to the data plane, the data plane is able to send the access request to a pod in a corresponding cluster based on the virtual IP address.

In the above embodiment, the control plane synchronizes the resources of the primary cluster and the sub-clusters, and sends the relevant information of the synchronized resources to the data plane. The data plane generates the plurality of virtual IP addresses. After configuring each resource with a corresponding virtual IP address, the data plane is able to forward an access request to the corresponding cluster, thereby solving the problem of multi-cluster access.

FIG. 2 is a flowchart of a multi-cluster access method according to other embodiments of the present disclosure.

In step 210, synchronize resources between the primary cluster and the sub-clusters by the cluster manager.

In some embodiments, in order to achieve global load balancing, the abilities of pods in a plurality of clusters are collected. As a core component, the cluster manager is able to solve the problem of pod collection across multiple clusters. For example, the cluster manager in the primary cluster interacts with a cluster manager in each sub-cluster, obtaining the resource of each pod in each sub-cluster, and synchronizing the resource of each pod in the primary cluster to each sub-cluster. In this way, the sub-cluster is also able to obtain pod resources of other clusters.

In some embodiments, the cluster manager obtains a kubeconfig file from each sub-cluster in a configmap manner, wherein clusterinfo crd in the kubeconfig file is configured to store configuration information of the corresponding cluster.

In some embodiments, a CRD controller located in the primary cluster generates synchronized cluster manager pods based on cluster information, which are configured to synchronize resources with the sub-clusters. The cluster manager obtains kubeconfig configuration information in a mounting confgmap manner, and implements a master-slave backup mode for multiple pods via k8s locking.

In some embodiments, the configmap is able to achieve configuration management for applications in containers; the kubeconfig file is an authentication file for the k8s API server (Application Programming Interface Server), which comprises Cluster, User, Namespace, and Authentication Mechanism information; spec. config: store configuration files for the primary cluster and the sub-clusters.

In step 220, the cluster manager stores the resource of each pod in the database, and stores snapshot information corresponding to the resource of each pod in the CRD file.

In a case where a single pod interacts with multiple clusters for data, if the amount of data is large, for example, if there is a large amount of cluster data, the performance of etcd (a distributed key value storage system) supporting big data storage will also decrease. In this embodiment, the resources of pods are stored in the database, and the snapshot information corresponding to the resource of each pod is stored in the CRD file. By querying the CRD, information about each pod can be found, which can reduce the storage pressure on the primary cluster's etcd.

In some embodiments, the CRD file also stores load balancing rule information.

In some embodiments, a four-layer load balancing CRD file, namely L4CRD file, and a seven-layer load balancing CRD file, namely L7CRD file, in the primary cluster, are used to record the relationship between resources in clusters and load balancing. A federalEndpoint CRD file in the primary cluster is used to record pods in sub-clusters.

In some embodiments, the cluster manager creates services in the sub-clusters when processing the L4CRD and L7CRD files and binds Endpoint information to federalEnjoin.

In some embodiments, the CRD file can be queried, created, updated, or deleted based on user instructions, thereby achieving the querying, creating, updating, and deleting of multi-cluster resources.

In step 230, the load balancer controller sends the load balancing rule information stored in the CRD file, as well as the snapshot information corresponding to the resource of each pod, to the data plane.

In step 240, the data plane generates the plurality of virtual IP addresses and feeds them back to the load balancer controller.

In some embodiments, the data plane generates the plurality of virtual IP addresses based on load balancing rule information and the snapshot information corresponding to each pod, and feeds back the virtual IP addresses to the load balancer controller.

In step 250, the load balancer controller binds the snapshot information corresponding to the resource of each pod to a virtual IP address.

In step 260, after receiving an access request, the data plane forwards the access request to the pod in the corresponding cluster based on the IP address.

In some embodiments, the load balancer controller obtains a backend IP address through the federalEndpoint of the primary cluster, obtains load balancing rules from the L4CRD and L7CRD, and binds the virtual IP address obtained from the data plane to the L4CRD and L7CRD, thereby being able to distinguish between public IPs and private IPs.

In some embodiments, Kubernetes, as a docker (container) scheduling solution, provides users with a good cloud service experience, and the load balancer controller, as an important component of Kubernetes, provides users with a proxy means to access pods. However, changing docker IP addresses can be inconvenient for business use. In this embodiment, the data plane feeds back virtual IP addresses and the load balancer controller stores the correspondence between pods and virtual IP addresses in the CRD file, which can simplify access to services.

In some embodiments, a GDNS (Global Domain Name System) is used to bind the virtual IP address of each pod to the corresponding domain name.

For example, the GDNS retrieves the virtual IP address of each pod from the CRD file and binds it to the corresponding domain name, allowing the data plane to forward an access request to the pod in the corresponding cluster based on the domain name.

In related technologies, external load balancing allows ingresses of multiple clusters to be mounted, but two rounds of load balancing are required to reach a service container, and traffic cannot be evenly distributed. In this embodiment, an access request can directly reach the pod in the corresponding cluster.

In the above embodiment, the primary cluster obtains information about each pod in the sub-clusters and sends the information about each pod to the data plane through the load balancer controller. The data plane generates virtual IP addresses, and the load balancer controller configures each pod with a virtual IP address, thereby enabling access to pods in multiple clusters. This process does not violate the sub-clusters and provides a consistent access method for the management end by shielding the underlying differences. Regardless of which management end the access request comes f this disclosure provides a smooth interface with sub-clusters to achieve load balancing.

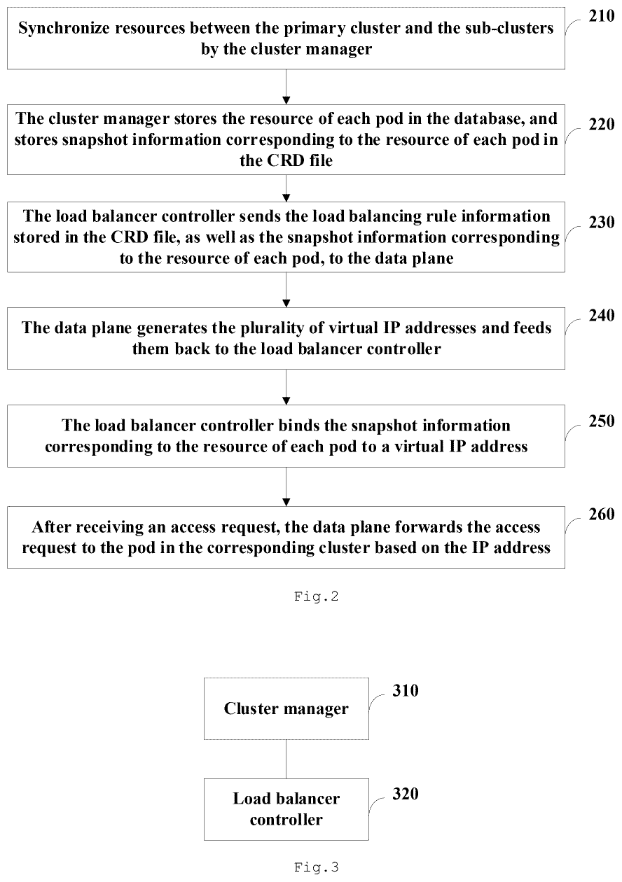

FIG. 3 is a schematic diagram of the structure of a multi-cluster access system according to some embodiments of this disclosure. The system comprises a cluster manager 310 and a load balancer controller 320 located on the primary cluster side.

The cluster manager 310 is configured to synchronize resources between the primary cluster and the sub-clusters.

In some embodiments, the cluster manager 310 located in the primary cluster is configured to interact with the cluster manager in each sub-cluster, obtain the resource of each container instance pod in each sub-cluster, and synchronize the resource of each pod in the primary cluster to each sub-cluster.

In some embodiments, the cluster manager 310 is configured to use obtain the kubeconfig file of each sub-cluster in a ConfigMap manner, wherein clusterinfo crd in the kubeconfig file is configured to store configuration information of the corresponding cluster.

In some embodiments, as shown in FIG. 4, the system further comprises a CRD file 410 configured to store snapshot information corresponding to the resource of each pod. For example, the cluster manager 310 stores the resource of each pod in a database, and stores snapshot information corresponding to the resource of each pod in the CRD file 410.

In some embodiments, the CRD file 410 also stores load balancing rule information.

In some embodiments, querying, creating, updating, and deleting operations are performed on the CRD file 410 based on user instructions. The CRD file 410 is an L4CRD file or an L7CRD file.

The load balancer controller 320 is configured to send relevant information of synchronized resources to the data plane, receive the plurality of virtual IP addresses as feedback from the data plane, and configure each resource with a virtual IP address corresponding to a cluster access request.

In some embodiments, the load balancer controller 320 sends the load balancing rule information stored in the CRD file, as well as the snapshot information corresponding to the resource of each pod, to the data plane. The data plane generates the plurality of virtual IP addresses based on the load balancing rule information and the resource related information, and feeds back the virtual IP addresses to the load balancer controller 320.

In some embodiments, the load balancer controller 320 is configured to bind the snapshot information of the resource of each pod to a virtual IP address. After receiving the access request, the data plane forwards the access request to the pod in the corresponding cluster based on the IP address.

In other embodiments of this disclosure, the system further comprises a global domain name system 420 configured to bind the virtual IP address of each pod to the corresponding domain name. The data plane can forward the access request to the pod in the corresponding cluster based on its domain name.

In the above embodiment, the control plane achieves resource synchronization between the primary cluster and the sub-clusters, and sends the relevant information of the synchronized resources to the data plane. The data plane generates the plurality of virtual IP addresses. After configuring each resource with the corresponding virtual IP address, the data plane is able to forward the access request to the corresponding cluster, thereby achieving multi-cluster access. In addition, this disclosure provides a unified access method for the management end by shielding the underlying differences, and enables a smooth interface with sub-clusters to achieve load balancing regardless of which management end the access request comes from.

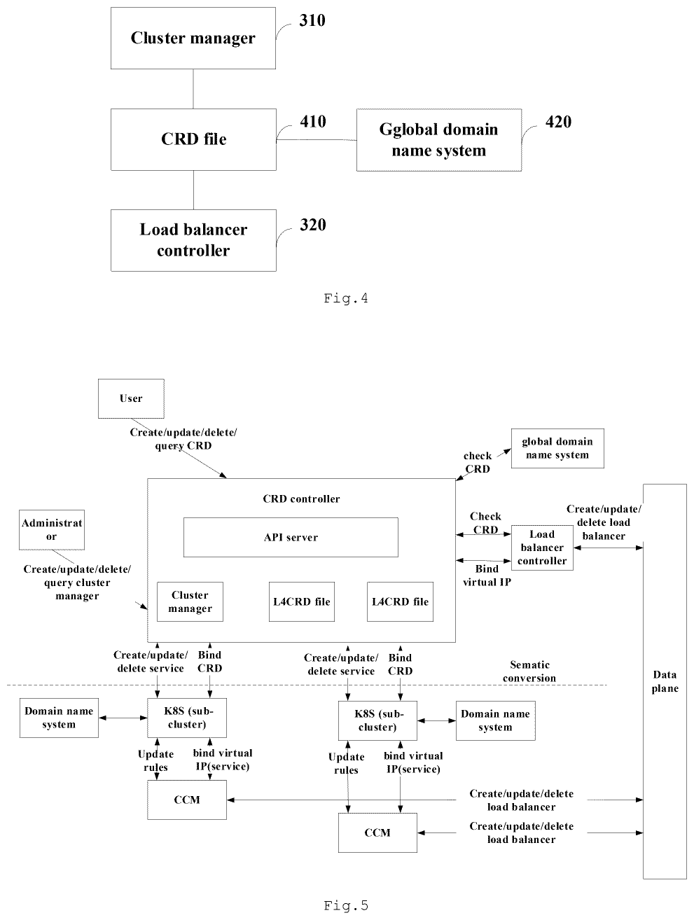

In some specific embodiments, as shown in FIG. 5, the CRD controller generates synchronized cluster manager pods based on cluster information. An administrator is able to create, update, and delete the cluster manager. The cluster manager creates a service in the sub-cluster when processing the L4CRD or L7CRD file and binds Endpoint information to federalEnjoin. As the core of the cluster, the API Server is responsible for communication between various functional modules in the cluster. Each functional module in the cluster stores information in etcd through the API Server. A CCM (Cloud Provider Manager) is a single cluster load balancer that implements load balancing functionality.

In the promotion process of Kubernetes, multiple deployment methods are supported for cross data center/cross regional disaster recovery, such as grey release, canary release, a/b testing, etc. To address the differences in multi-cluster load balancing solutions and the differences in domain name servers in business scenarios, this disclosure provides a unified access method for the management end by shielding the underlying differences, and can smoothly interface with sub-clusters for load balancing.

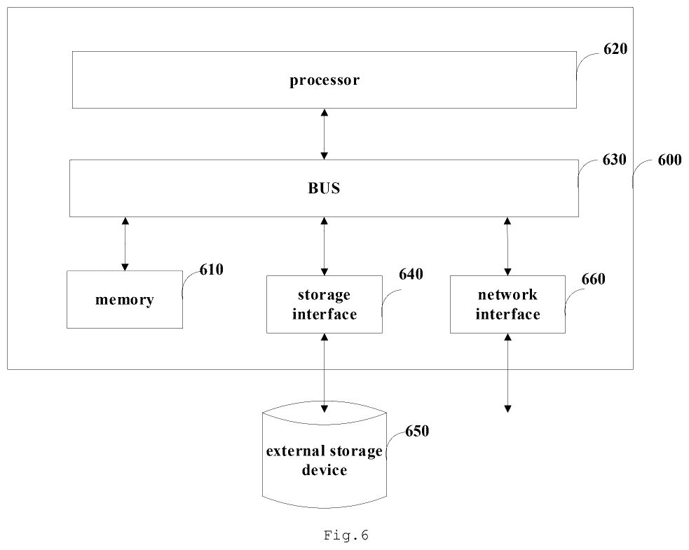

FIG. 6 is a structure diagram of a multi-cluster access system according to further embodiments of the present disclosure, The system 600 comprises a memory 610 and a processor 620. Wherein the memory 610 may be a magnetic disk, flash memory or any other non-volatile storage medium. The memory 610 is configured to store instructions of a corresponding embodiment described above. The processor 620 is coupled to the memory 610 and may be implemented as one or more integrated circuits, such as a microprocessor or microcontroller. The processor 620 is configured to execute the instructions stored in the memory.

In some embodiments, the processor 620 is coupled to the memory 610 via a bus 630. The system 600 may be further connected to an external storage device 650 through a storage interface 640 to access external data, and may be further connected to a network or another computer system (not shown) through a network interface 660, which will not be described in detail herein.

In the above embodiment, through storing data instructions in memory and processing the above instructions using a processor, multi-cluster access can be achieved.

In other embodiments, there is provided a computer-readable storage medium stored thereon computer program instructions that, when executed by a processor, implement the steps of the method of the above embodiment. One skilled in the art should understand that, the embodiments of the present disclosure may be provided as a method, an apparatus, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical storage device, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing apparatus to generate a machine such that the instructions executed by a processor of a computer or other programmable data processing apparatus to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture including instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

According to some embodiments of the present disclosure, there is further provided a computer program, comprising: instructions that, when executed by a processor, cause the processor to perform the multi-cluster access method described above.

Heretofore, the present disclosure has been described in detail. In order to avoid obscuring the concepts of the present disclosure, some details known in the art are not described. Based on the above description, those skilled in the art can understand how to implement the technical solutions disclosed herein.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

1. A multi-cluster access method, comprising:
synchronizing resources between a primary cluster and sub-clusters;
sending relevant information of synchronized resources to a data plane;
receiving a plurality of virtual IP addresses feedback from the data plane; and
configuring each resource with a virtual IP address corresponding to a cluster access request.

2. The multi-cluster access method according to claim 1, wherein the synchronizing resources comprises:
interacting, by a cluster manager in the primary cluster, with a cluster manager in each sub-cluster, obtaining the resource of each pod in each sub-cluster, and synchronizing the resource of each pod in the primary cluster to each sub-cluster.

3. The multi-cluster access method according to claim 2, wherein the synchronizing resources further comprises:
storing the resource of each pod in a database, and storing snapshot information corresponding to the resource of each pod in a Custom Resource Definition (CRD) file.

4. The multi-cluster access method according to claim 3, wherein configuring the virtual IP address comprises:
binding the snapshot information corresponding to the resource of each pod to a virtual IP address.

5. The multi-cluster access method according to claim 3, wherein
one or more of querying, creating, updating, and deleting operations are performed on the CRD file based on user instructions.

6. The multi-cluster access method according to claim 2, further comprising:
binding the virtual IP address of each pod to a corresponding domain name.

7. The multi-cluster access method according to claim 1, further comprising:
sending load balancing rules to the data plane, wherein the virtual IP addresses are generated based on the load balancing rules and relevant information of resources.

8. The multi-cluster access method according to claim 2, wherein obtaining the resource of each pod in each sub-cluster comprises:
obtaining a kubeconfig file of each sub-cluster in a configmap manner, wherein clusterinfo crd in the kubeconfig file is configured to store configuration information of the corresponding cluster.

9. A multi-cluster access system, comprising:
a cluster manager configured to synchronize resources between a primary cluster and sub-clusters; and
a load balancer controller configured to send relevant information of synchronized resources to a data plane, receive a plurality of virtual IP addresses feedback from the data plane, and configure each resource with a virtual IP address corresponding to a cluster access request.

10. The multi-cluster access system according to claim 9, wherein
the cluster manager is configured to interact with a cluster managers in each sub-cluster, obtain the resource of each pod in each sub-cluster, and synchronize the resource of each pod in the primary cluster to each sub-cluster.

11. The multi-cluster access system according to claim 10, further comprising:
a Custom Resource Definition (CRD) file configured to store snapshot information corresponding to the resource of each pod.

12. The multi-cluster access system according to claim 11, wherein
the load balancer controller is configured to bind the snapshot information of the resource of each pod to a virtual IP address.

13. The multi-cluster access system according to claim 11, wherein
one or more of querying, creating, updating, and deleting operations are performed on the CRD file based on user instructions.

14. The multi-cluster access system according to claim 10, further comprising:
a global domain name system configured to bind the virtual IP address of each pod to a corresponding domain name.

15. The multi-cluster access system according to claim 9, wherein
the load balancer controller is further configured to send load balancing rules to the data plane, wherein the virtual IP addresses are generated based on the load balancing rules and relevant information of resources.

16. The multi-cluster access system according to claim 10, wherein
the cluster manager is configured to obtain a kubeconfig file of each sub-cluster in a configmap manner, wherein clusterinfo crd in the kubeconfig file is configured to store configuration information of the corresponding cluster.

17. A multi-cluster access system, comprising:
a memory; and
a processor coupled to the memory, the processor configured to, based on instructions stored in the memory, carry out a multi-cluster access method, comprising:
synchronizing resources between a primary cluster and sub-clusters;
sending relevant information of synchronized resources to a data plane;
receiving a plurality of virtual IP addresses feedback from the data plane; and
configuring each resource with a virtual IP address corresponding to a cluster access request.

18. A non-transitory computer-readable storage medium stored thereon computer program instructions that, when executed by a processor, implement the multi-cluster access method according to claim 1.

19. (canceled)

20. The multi-cluster access system according to claim 17, wherein synchronizing resources comprises:
interacting, by a cluster manager in the primary cluster, with a cluster manager in each sub-cluster, obtaining the resource of each pod in each sub-cluster, and synchronizing the resource of each pod in the primary cluster to each sub-cluster.

21. The multi-cluster access system according to claim 17, wherein the multi-cluster access method, further comprises:
sending load balancing rules to the data plane, wherein the virtual IP addresses are generated based on the load balancing rules and relevant information of resources.
